(19) United States
(12) Patent Application Publication
(10) Pub. No.: US 2009/0144493 A1
(43) Pub. Date: Jun. 4, 2009

(54) Circular Buffer Maping

(75) Inventor: Vladimir Stoyanov, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/948,922

(22) Filed: Nov. 30, 2007

(51) Int. Cl. G06F 12/00

(52) U.S. Cl. 711/110; 711/E12.001

(57) ABSTRACT

Techniques for mirroring circular buffer mapping are discussed. Mirroring mapping for buffered message data, such as streaming data which may permit rapid data access for message data is circularly buffered. A first map and a second map may be linearly arranged in virtual memory space such that a reading of the first and or second maps, beginning from a fixed position within one of the maps, may permit parsing of the message data as if, the message was linearly arranged in the buffer.

### BACKGROUND

Decoding streaming data may be problematic as the manner in which the data is received may result in the receiving system having to receive additional data before decoding the message. For instance, when receiving a transmission control protocol/internet protocol (TCP/IP) data stream the receiving system may wait to receive a sufficient portion of a message in order to proceed with decoding the message. As a result, the initial portion of the flowing data may be temporarily stored, until the remainder of the message is received. The initial portion of the streaming data, may be copied into a buffer so that the data in memory and the additional incoming data, is aligned in the buffer. Copying the data may be time consuming.

### SUMMARY

Techniques for mirroring circular buffer mapping are discussed. Mirroring mapping for buffered message data, such as streaming data which may permit rapid data access for message data is circularly buffered. A first map and a second map may be linearly arranged in virtual memory space such that a reading of the first and or second maps, beginning from a fixed position within one of the maps, may permit parsing of the message data as if, the message was linearly arranged in the buffer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an environment in exemplary implementations that may use mirrored circular buffer mapping.

FIG. 2. illustrates map reading of buffered data and mirrored mapping.

FIG. 3 is a flow diagram depicting a procedure in exemplary implementations in which mirrored buffer mapping is used.

FIG. 4 is a flow diagram depicting a procedure in exemplary implementations in which mirrored buffer mapping of streaming data is used.

### DETAILED DESCRIPTION

Overview

Accordingly, techniques are described which may provide mirrored buffer mapping. For example, mirrored buffer mapping may be used when accessing data in the buffer for one or more portions of a message which are to be decoded together. Mirrored mapping may permit eventual data access beginning from various starting points within either a first map or a second map which mirrors the first map. In this fashion, a linear reading of the first map and/or second map may be conducted starting from a fixed point within the first map or the second map. Thus, the buffer content may be parsed linearly according to one or more of the maps although the retained data may be non-linearly retained in the buffer. This procedure may permit data buffering, while avoiding a memory copy in which data in memory may be copied to the buffer.

In implementations, a system including a buffer may be configured to contiguously map a first map and a second map which, individually, map the physical location of one or more portions of a message. The buffer may be configured to buffer the data, such as a transmission control protocol over internet protocol (TCP/IP) message, which is retained in non-contiguous locations in the buffer. The buffer may map the locations of the portions of the buffered data in a first map. A copy of the first map may be mirrored adjacent to the first map such that accessing the buffered data may begin from a fixed point in one of the maps although the data may be non-linearly arranged in the buffer.

Exemplary Environment

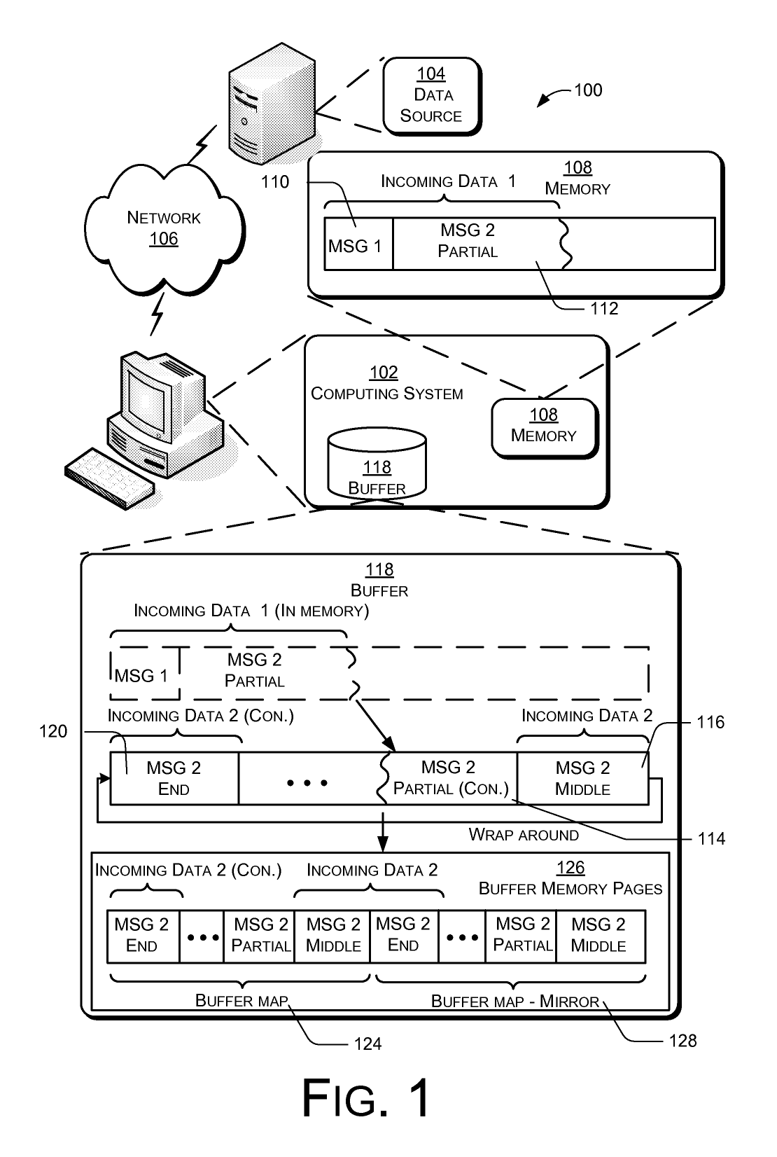

FIG. 1 illustrates an environment 100 in exemplary implementations that may permit circular buffer mapping. The computing system 102 may be configured to receive a message including data for decoding. For example, one or more messages may be included in a data stream of information operating in accordance with TCP/IP. In other implementations, the message may be video data, audio data, other types of streaming data and so on.

As the messages are obtained, such as from a data source 104 via a network 106, the streaming data may be transferred into memory 108 for use by the application operating on the computing system 102. For example, a first data communication may include a first message (MSG1) 110 which is received into memory 108, while a second message (MSG2) may be received partially in a first incoming data (MSG2 partial) 112. The additional portion of the second message may be buffered (e.g., MSG2 partial (con.) 114, MSG2 middle 116) and subsequent communications may be buffered as well. An application accessing the messages in memory may realize that more data should be received before decoding. For example, if additional data should be included so that the content may be understood by the application. Thus, the remainder of the second message, the portion of the message which may include a sufficient amount of data so decoding may commence, may be retained in a buffer 118 for access by the application.

For example, the remaining portion(s) of MSG2 may be retained in the buffer 118 in a wrap-around manner. Instead of copying the first portion of MSG2 (partial) 110 at the beginning of the buffer 118 (e.g., the portion of MSG2 which is in memory 108), followed by the other portions of the MSG2 message. In the present implementations, the subsequently received data in MSG2 may be transferred and placed in the buffer so that the end of the first incoming data may be stored in the buffer without copying the portion of MSG2 which is in memory. The remaining portion of MSG2, including a partial continuation portion 114, the middle of MSG2 116, the end of MSG2 120 and so on, may be read to the buffer for retention. For example, while incoming data 1, including MSG1 110 and a partial portion of MSG2 112, may be in memory, incoming data 2, including the middle an end of MSG2, may be retained in the buffer 118 in a non-continuous manner, e.g., in a wrap around manner. For example, the portions of the message which are subsequently received or may exceed the receiving systems physical capacity of the memory, may be placed at the end of the buffer, the end portion of the message may be wrapped around to the beginning of the buffer. As a result, the complete data forming the message may not be physically adjacent in the buffer.

The physical location of the data forming the message in the buffer 118 may be mapped. For example, a first map 124, which includes the physical addresses of the buffered data, may be retained in the buffer memory pages 126. A second map 128 or a mirror of the first map 124 may be included in the buffer memory pages 126. The first map 124 and the second map 128 may map the data to identical physical locations in the buffer 118. In implementations, the first map 124 and the second map 128 may be contiguous. For example, the mirror or second map 128 may be directly subsequent to the first map 124 in virtual memory space.

When parsing the data forming the message from the buffer 118, the physical location of the data within the buffer 118 may be linearly read from the first map 124 and/or the second map 128 or a combination of the maps. For example, when attempting to ascertain the address of the message data in the buffer 118, a map read may commence from a fixed start point for the map(s) although the relevant data may not be physically adjacent in the buffer 118.

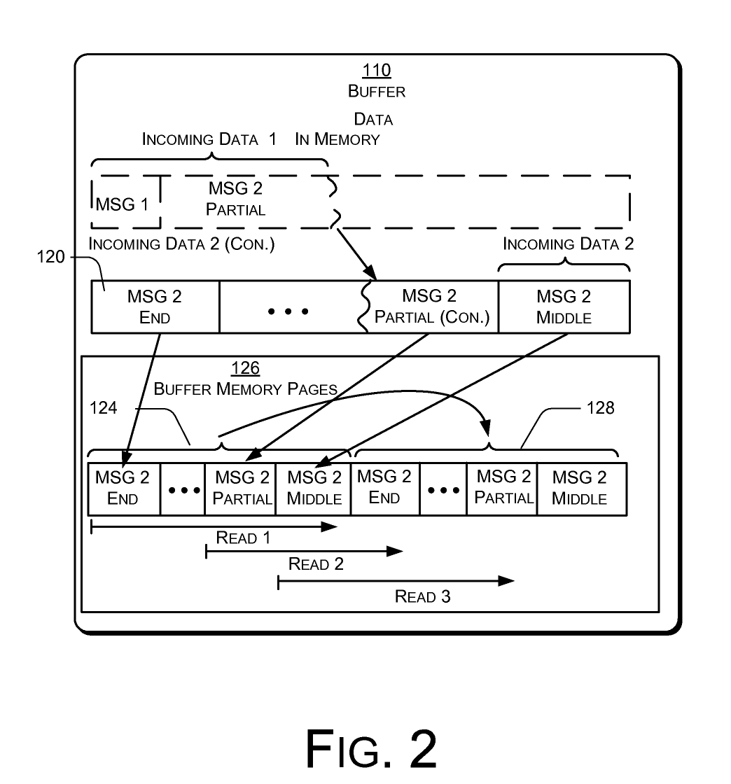

Using the map(s) may permit linear data parsing as the message data may be accessed, for use by other layers of the protocol stack, e.g., an application, according to the of the first and/or second maps. A read from the map(s) may commence from a fixed point in either of the first map or the second map. For instance, the buffer may read MSG2 data commencing from the beginning of the partial portion of MSG2 (partial (con.) 114), e.g., where MSG2 partial left-off due to subsequent transmission or for other reasons such as memory capacity (e.g., read 2, FIG. 2, in the first map 124 while MSG2 end addressing is read from the second map 126. The data in the buffer 118 may be parsed according to the map reading so that, the buffer 118 forwards the data in compliance with the maps, even though the message data may not be linearly arranged in the buffer 118. As noted above, other reads including Read 1 and Read 3 (FIG. 2) may be preformed. The data, forming the message, may not be physically adjacent due to the buffer 118 circularly wrapping the message data around the buffer. In this manner, in virtual memory space, the message may appear to be linearly configured, while the data may be retained in a physically convenient manner.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., tangible memory and so on.

The following discussion describes transformation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

Exemplary Procedures

The following discussion describes a methodology that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. A variety of other examples are also contemplated.

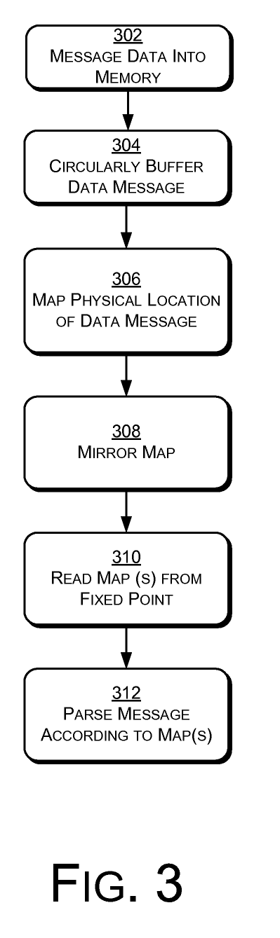

FIG. 3 discloses exemplary procedures for circularly buffering data such as streaming data communicated in accordance with TCP/IP, video data, audio data, and so on. For example, a series of communications including messages may be communicated to a computing system for use. While a first message (MSG1) and a portion of a second message (MSG2 partial) may be entered into memory 302, the remainder of MSG 2 may be buffered 304 for use by an application accessing the data. A subsequent communication including MSG2 middle and MSG2 end may be buffered in a circular manner, as well.

Following the above example, the portion of MSG2 which is subsequently received or may exceed the systems memory's capability may be circularly buffered 304. For example, the when buffering the additional portion of the first communication (e.g., MSG2 partial con.) followed by the middle of MSG2 (received in a second communication) may be physically retained at the end of the buffer while the end of the message (MSG2 end, received in the second communication, may be wrapped around the buffer so the data is physically retained at the beginning of the buffer. For example, the data forming the messages may be non-linearly buffered so that the data forming the messages are physically non-contiguous to the other portions of the message.

The physical location of the message in the buffer may be mapped 306 to the buffer memory pages. In implementations, a first map which maps the physical location of the portions of MSG2, for example, may be mirrored 308 by a second map which may be located contiguous to the first map virtual memory space. In this manner, a first copy of the physical location of the data in the buffer may be adjacent to a second map which points to identical physical locations of the data. For example, the second map may be directly subsequent to the first map.

While the data forming the message may be located in a non-continuous manner, upon reading 310 one or more of the first map and/or the second map the addresses of the message data in the buffer may be ascertained for parsing 312 the messages. In the above example, the application may realize that additional portions of the communications should be obtained from the buffer in order to decode the message. For example, an application, or other layers of the protocol stack, may parse the data according to the maps in order to permit accessing the messages as if the message data appeared in a linear arrangement.

The first map and/or the second map may be read 310 from a fixed point in one of the maps in a linear fashion. Using the maps may result in the data being decoded linearly in virtual space, although the data may be physically retained in a non-linear arrangement. For instance, reading 310 the maps may result in the message data being parsed or decoded as if, the end of MSG2 appeared, linearly, after the middle of MSG2 (e.g., in virtual memory space).

For example, a map reading may commence with MSG2 partial (con.) in the first map, and proceed linearly through MSG2 end (appearing in the second map). Using the physical addressing of data from the maps may result in the data being parsed from the buffer as if, were retained in a linear arrangement.

The above techniques may avoid slow memory copies associated with copying a portion of a message into the buffer so as to allow linear parsing and passing of the data to other layers in the protocol stack. For instance, copying MSG2 partial into the buffer may be avoided.

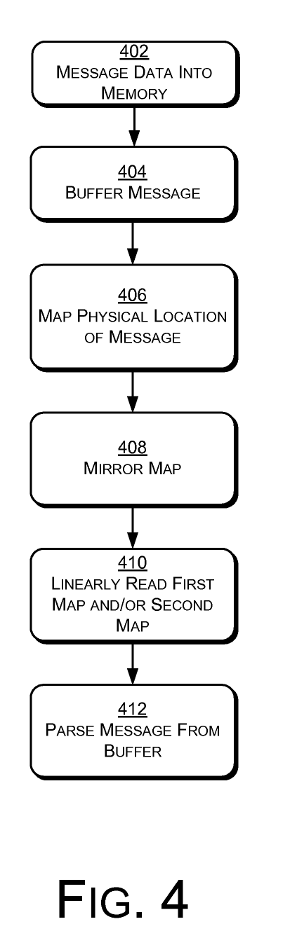

Referring to FIG. 4, computer readable media and accompanying techniques are discussed for mirrored buffer mapping, such for use with circular data buffering. For example, streaming data may be handled in accordance with the present techniques to avoid time consuming memory copies for messages which are received in portions, such as messages in accordance with TCP/IP.

An application receiving messages 402 may recognize that additional portions of the message should be received before decoding the message. The remaining portion of the message data may be buffered 404. For example, the end of a message may be retained in memory for eventual parsing, while the beginning of the message, which was previously transferred, may be parsed for use by the higher layers of the protocol stack.

The location of the buffered message may be mapped 406 in the buffer physical memory pages. A map may include the physical buffer addresses for the data forming the message. When reading the map, the location of the data forming the message in the buffer may be ascertained in order to retrieve the message for decoding by the application.

The first map may be mirrored 408 by a second map which includes identical addressing for the message retained in the buffer. For instance, the second map may be arranged in virtual memory space, so that the buffered message may be accessed as if, the message was in a linear physical arrangement. This arrangement may permit the message data to be circularly buffered, while the data may appear to be linearly accessible. The second map may be adjacent the first map, such as directly subsequent to the first map, in virtual memory space so that an application or other higher level of the protocol stack may linearly read 410 the first map and or second map in order to parse the buffered message (e.g., portions) for decoding. This may be performed if additional portions of the message are desired in order to decode the message. For instance, in previous examples, if the application realizes that MSG2 partial and the remainder of MSG2 may be decoded for correctness, the additional portions of MSG2 may be parsed by implementing a read of the first and/or second maps starting at a fixed position with one of the maps.

The physical addresses may be used to parse the messages in order to utilize the data. Exemplary messages include streaming data, including data incompliance with TCP/IP, streaming video and or audio data and so on.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
buffering a portion of a data message for decoding the data message; and
mirroring a first map, of physical locations of portions of the buffered data message, to a second map, which mirrors the first map, adjacent to the first map.

2. The method as described in claim 1 wherein the data message is circularly buffered.

3. The method as described in claim 1 wherein the data message is wrap-around buffered.

4. The method as described in claim 1 further comprising linearly reading physical locations of the buffered data from at least one a portion of the first map or the second map.

5. The method as described in claim 1 wherein the second map is located directly subsequent to the first map.

6. The method as described in claim 1 wherein the first map and the second map are retained in the buffer's physical memory pages.

7. The method as described in claim 1 wherein the data message is a transmission control protocol over internet protocol (TCP/IP) message.

8. The method as described in claim 1 wherein the data message is a streaming message including at least one of video content or audio content.

9. The method as described in claim 1 wherein a portion of the message received into the memory is not copied to the buffer.

10. One or more computer-readable media comprising computer-executable instructions that, when executed, direct a computing system to:
mirror a first map, of a portion of a buffered streaming message, to a second map, adjacent to the first map, such that a map of the buffered streaming message is linearly readable starting in either the first map or the second map.

11. The one or more computer-readable media as described in claim 10 further comprising linearly read the map starting at a point in at least one of the first map or the second map.

12. The one or more computer-readable media as described in claim 10 wherein the second map is located directly subsequent to the first map.

13. The one or more computer-readable media as described in claim 10 wherein the streaming message is a transmission control protocol over internet protocol (TCP/IP) message.

14. The one or more computer-readable media as described in claim 10 wherein the first map and the second map are retained in buffer physical memory pages.

15. The one or more computer-readable media as described in claim 10 wherein the streaming message is circularly buffered.

16. A system comprising:
a buffer configured to contiguously map a first map and a second map, individually including, physical locations of buffered data.

17. The system of claim 16 wherein the buffer is configured to read the physical location of buffered data starting from a point in either of the first map or the second map.

18. The system of claim 16 wherein the first map and the second map are contiguous in virtual memory space.

19. The system of claim 16 wherein buffered data is transmission control protocol over internet protocol (TCP/IP) data.

20. The system of claim 16 wherein the buffer retains buffered data in non-contiguous physical locations.
